(19) United States
(12) Patent Application Publication
(10) Pub. No.: US 2007/0045447 A1
(43) Pub. Date: Mar. 1, 2007

(54) Handgrip powered pressurized air sprayer

(76) Inventor: Daniel J. Wipper, McHenry, IL (US)

Correspondence Address: Daniel J Wipper, 719 East Blvd., McHenry, IL, 60051, US

(21) Appl. No.: 11/218,228

(22) Filed: Aug. 31, 2005

(51) Int. Cl. A62C 11/00; B05B 9/04

(52) U.S. Cl. 239/333; 239/373

(57) ABSTRACT

The sprayer of this invention is a crossbreed that combines the benefits of a pressurized air sprayer with the convenience a common bottle-top trigger sprayer. However, activating the trigger now has a reverse action causing the related pump to ingest air and the pump's traditional flow direction is now reversed. Air is passed into a reinforced reservoir bottle, near the top, similar to a pressurized air sprayer. Multiple hand-trigger-pulls are used to pre-pressurize air into the reservoir's chamber. A second conduit starting within and near the bottom of the reservoir utilizes air pressure to transfer product within the reservoir to a dispensing-valve. A means is provided to operate the dispensing-valve, which is able to dispense product continuously in-between compression strokes.

### FIELD OF THE INVENTION

The present invention relates in a method for combining and improving two existing types of common day sprayers, retaining the most beneficial features of each and creating a hybrid between a bottle-top trigger sprayer and a hand operated, pre-pressurized, air powered sprayer. This new product will fulfill the needs for many applications and create a line of sprayers that are superior to common bottle-top trigger sprayers and more convenient than present day pressurized-air sprayers. More particularly, this invention demonstrates a method of building pressurized-air sprayers that are pre-pressurized utilizing a finger or handgrip squeezing motion.

### BACKGROUND OF THE INVENTION

U.S. PATENT DOCUMENTS

| | | |
|---|---|---|
| 4,196,828 | 4/1980 | Basil |
| 4,235,353 | 11/1980 | Capra |
| 4,537,334 | 8/1985 | Spengler |
| 4,872,595 | 10/1989 | Hammett |
| 5,183,185 | 2/1993 | Hutcheson |
| 5,522,547 | 06/1996 | Dobbs |
| 5,535,950 | 07/1996 | Barriac |
| 6,053,372 | 04/2000 | Abedi |
| 6,279,784 | 8/2001 | O'Neill |
| 6,527,202 | 3/2003 | Tseng |

U.S. Pat. No. 4,196,828 Basile, U.S. Pat. No. 4,537,334 Spengler, and U.S. Pat. No. 6,053,372 Abedi are all traditional pump-up sprayers by where one hand usually holds the reservoir while the other hand operates the pump. Basile and Spengler utilize a conventional knob on top of the sprayer to operate the pump. In the Abedi design the whole sprayer head becomes a handle for the pump. These sprayers are pre-pressurized, pump-up sprayers that are powered by the operator's hand and arm forces and are not pressurized in a handgrip fashion.

U.S. Pat. No. 4,235,353 Capra, U.S. Pat. No. 4,872,595 Hammett, and U.S. Pat. No. 5,183,185 Hutcheson are all secondary compressed reservoir sprayers. Here product from the main reservoir is pumped into a second reservoir that holds the product under pressure through a mechanical means. The Capra sprayer's second reservoir maintains this pressure utilizing a spring and piston. Hammett and Hutcheson utilize a resilient rubber bladder to store the product under pressure. These sprayers may be operated by one hand though do not use pre-pressurized air to dispense their product.

U.S. Pat. No. 6,279,784 O'Neill and U.S. Pat. No. 6,527,202 Tseng eliminate metal springs in the pump. Both do not pre-pressurize air and otherwise function like normal bottle-top trigger sprayers.

U.S. Pat. No. 5,522,547 Dobbs is a valve system that builds and regulates product pressure just prior to the nozzle for improved distribution.

U.S. Pat. No. 5,535,950 Barriac is one of many methods of dispensing two products with one pump stroke. Mentioned is a dual-trigger, though unlike the present invention it has one trigger that operates two pumps simultaneously.

Many patents for various sprayer designs exist however, we have found no evidence of any type of pre pressurized air sprayers that are pressurized with a handgrip squeeze motion also none in which pressurizing the reservoir and dispensing the product can be accomplished using just one hand.

Most other patent ideas refer to plans for cheaper construction, mixing two liquids, child proofing, pressure regulation, nozzle configurations, remote pressurizing, motion pressurizing, and electric pumps. Other existing patents disclose variables with differing hardware and goals when compared to this proposed Wipper invention.

### SUMMARY OF THE INVENTION

It is a primary object of the present invention to combine the benefits of both pressurized-air sprayers and bottle-top trigger sprayers. Providing the many benefits attributed to pressurized-air sprayers in combination with the convenient single-handed pumping and dispensing actions found in common trigger sprayers. It would be common knowledge that both sprayers have their own unique benefits.

The common bottle-top trigger sprayers most often used offer the following benefits. They are the spray bottle pumps we are the most familiar and comfortable with. These familiarities should be beneficial for consumer acceptance in a new sprayer's design. One of the most important design features would be that pumping is done using only one hand in a pistol-grip hand-squeeze fashion. The hand-trigger's position and angle are comfortable and good for aiming the product's flow. Also, the hand-trigger may act as a hook to hang the sprayer from. These sprayers are generally used in combination with smaller reservoirs of less than one quart.

Common pressurized air sprayers have many benefits that are superior to features found in standard trigger sprayers. These benefits include that the liquid being dispensed does not pass through the pump mechanism and only air passes through the pump. Therefore, any chemical being dispensed will not make contact with and cause premature harm to the pump. A higher and more consistent operating pressure may also be achieved. These features allow for a much wider range of products that can be dispensed. The products dispensed can be, more chemically destructive, hotter, or of thicker viscosity. Another important benefit is the ability to spray continuously in-between re-pressurizing pumps. This allows for the application of products that require a more even distribution pattern. Also, a pump of this design is generally more durable when compared to a trigger sprayer. This type of sprayer is generally used with larger reservoirs of over one quart in size.

The new design of this invention fills a void between the two sprayers described. It would be used for applications requiring a small reservoir capacity usually 1 to 16 ounces as compared to traditional pressurized air sprayers that are usually over 16 ounces and range up to a few gallons. The smaller size that is usually found in a bottle-top trigger sprayer is now provided with the benefits of a compressed air sprayer while retaining the trigger sprayers convenient features. In other designs the smaller pressurized air powered sprayers required two hands to operate the pump associated with pressurizing air into the reservoir.

Sprayers themselves have a wide variety of uses. They are used for distributing many products in many fields and are used for recreational, household, industrial, and commercial purposes.

Many patents for various sprayers have existed to meet a wide variety of needs. There are no known claims past or present that disclose the unique benefits claimed in the present Wipper invention.

### DETAILED DESCRIPTION OF THE INVENTION

It is the main objective of this invention to create a pressurized air sprayer where the means for compression is provided in a finger or handgrip squeeze motion.

One sprayer style of this invention would be to reverse the flow of a common bottle-top trigger sprayer. This is done in a way that the sprayer retains its familiar shapes we are accustomed to. This is an important feature for consumer acceptance. Instead of pumping out fluid, the pump now ingests air, compressing it into the reservoir bottle. The stored air pressure is utilized to dispense product within the reservoir through a conduit that is supplied with a valve and a means for its operation.

It is further an objective to produce a one-hand operable, finger or handgrip powered, pressurized-air sprayer. The position of the pumping mechanism could vary and be linked to, or directly attached to the sprayer's pump. Or a traditional pressurized sprayer that is provided a finger or handgrip surface, which is used to compress air for the reservoir.

In either design a handgrip squeeze motion is used to operate an air pump. Repetitive handgrip squeezing motions are used to compress air, which is deposited into the interior of a reinforced reservoir that contains a product to be dispensed. A conduit within and starting near the bottom of the reservoir transfers product to a valve that is supplied as a means for its operation. This means of operation could be any form triggering mechanism of its own or one operated by the main compression-trigger. When the compression-trigger is utilized a portion of that stroke could be dedicated to operating the dispensing-valve and is then a dual-purpose trigger. This trigger could be provided with a lock out device so the dispensing portion of the stroke is not accidentally used while pressurizing the reservoir. Another method would be to provide a latching mechanism that temporarily attaches the compression-trigger to the means for operating the dispensing-valve. Then when product dispensing is desired, the latching mechanism is activated so on this stroke the dual-purpose trigger also operates the dispensing-valve. This latching mechanism could be made in many various ways and should automatically disengage itself for the following compression strokes. It should also be made operable by the same hand that is operating the compression-trigger. When the dispensing-valve is opened, air pressure within the reservoir forces product up through the conduit past the valve and out through a desired orifice for its use.

### BRIEF DESCRIPTION OF THE DRAWINGS

It should be noted that some common parts such as springs or dispensing-valves are missing from some illustrations to better focus on the unique features of the illustration. The drawings may also vary in their scale from one figure to another.

FIG. 1 is a cross-section exploded view of one way to build a sprayer related to the present invention.

FIG. 2 is a partially assembled sprayer of FIG. 1 that shows the trigger levers prior to retraction. Also dispensing-trigger #4 is one of version of a trigger that could be operated without retracting the compression-trigger.

FIG. 3 is a sprayer similar to FIG. 1 utilizing alternate features; a smaller reservoir bottle style #20, unitized sprayer body/cap #21, flap style check-valve #22, seal/retainer #23 and a different dispensing-trigger style #24.

FIG. 4 is another view of the sprayer in FIG. 3 where the compression-trigger is shown before retraction, which displays dispensing-trigger #24 that would not cause accidental product disbursement if the sprayer is hung up by the compression-trigger #3.

FIG. 5 depicts another distribution-trigger style #25 wide enough so that it would always be exposed for use and again would not cause accidental product disbursement.

FIG. 6 is another preferred form of a sprayer body in accordance with this invention. One that utilizes a vertical pump assembly externally located above the reservoir. Also, a single dual-purpose trigger that is provided with one form of a device that could prevent dispensing product while using this single trigger for its compressing mode.

FIG. 7 is an assembled version of FIG. 6 that depicts the lockout features of thumb style trigger stop #50

FIG. 8 illustrates the direction of airflow #29 through piston assembly #27.

FIG. 9 is a top elevation view of trigger stop #50 that may be operated by either the right or left hand.

FIG. 10 illustrates an interactive lever # 38 as the means for operating a distribution-valve. This ambidextrous lever is designed for operating a valve that is opened when pulled outwardly from the sprayer body.

FIG. 11 depicts a lever #59 as the means for operating the dispensing-valve. This version of an ambidextrous lever would independently operate a valve that is opened when it is pushed into the sprayer body.

FIG. 12 displays the use of a remote reservoir #57.

FIG. 13 is another form of a spray body within the scope of this invention, which utilizes an internal style pump mechanism located inside the reservoir.

### REFERECE NUMERALS IN DRAWINGS

1. Air-intake/valve-retainer
2. First check-valve
3. Compression-trigger
4. Dispensing-trigger
5. Pump piston
6. Pump chamber
7. Second check-valve
8. Cap
9. Seal/valve-retainer
10. Reservoir standing style
11. Drawl-tube
12. Sprayer body
13. Dispensing valve assembly
14. Spring return assembly
15. Valve retainer
16. Nozzle
17. Trigger-guard
18. Trigger-stop
19. Filter
20. Reservoir hanging style
21. Unitized cap/sprayer body
22. First check-valve flap style
23. Seal/retainer for unitized sprayer body
24. Distribution-trigger designed for hanging
25. Extended distribution-trigger for hanging
26. Hinge pin/screws
27. Pump piston/check-valve assembly
28. Compressed air outlet into reservoir
29. Air flow
30. Return spring
31. Second check-valve cap
32. Exterior vertical pump sprayer body
33. Dual-purpose trigger
34. Second check-valve assembly
35. Air-inlet, piston hinge and guide area
36. Cap with over pressurization relief-valve
37. Contour for handgrip
38. Lever means for operating the dispensing-valve
39. Bend point
40. Thumb lever pad
41. Catch edge
42. Protruding edge
43. Interior style pump
44. Pump liner insert
45. Air passage into reservoir
46. Finger operated dispensing-valve
47. Second check-valve and combination cap seal
48. Integrated drawl-tube
49. Surface used for operate the dispensing-valve
50. Thumb style trigger-stop
51. Hole or pocket
52. Stop edge on trigger
53. Hinge points
54. Stop edge on thumb lever
55. Positive stop edge that contacts sprayer body
56. Thumb lever tabs
57. Remote reservoir
58. Means for hanging, belt clip, belt loops, hook
59. Lever means for operating dispensing-valve

### DETAILED DESCRIPTION OF THE PREFERRED EMBODIMENTS

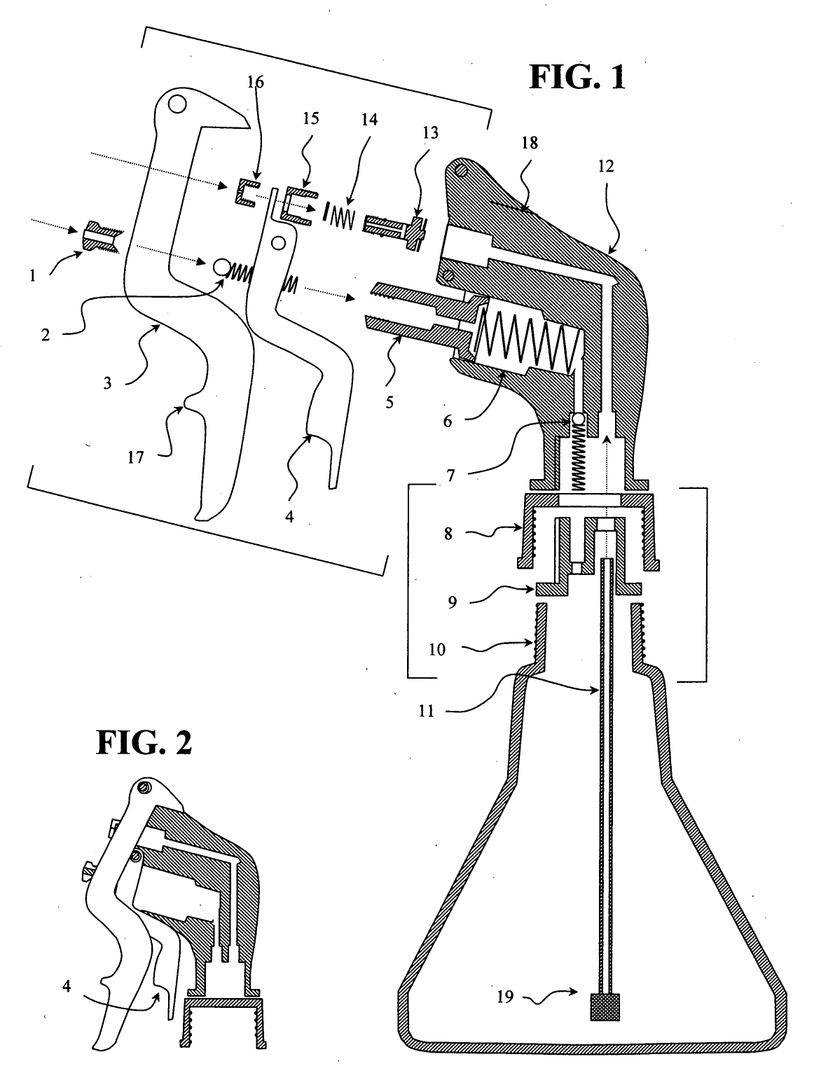

In reference to FIG. 1, in this style sprayer, air enters the system through air intake #1. In the design illustrated, the air-intake is part of an integrated check-valve system and also acts as a pivoting fastener for attaching the pump to the lever. When compression-trigger #3 is retracted air moves from pump chamber #6 through the second check-valve #7 into a reinforced reservoir chamber #10. When compression trigger #3 is released a spring within chamber #6 causes pump #5 to return for the next stroke while air is drawn into the system through intake #1. Air passes through the first check-valve #2, then through pump piston #5, into chamber #6. Multiple squeezes of compression-trigger #3 repeats these functions pre-pressurizing reservoir container #10. Air within reservoir #10, now pressurized, is utilized to push product out orifice #16 for distribution. When the product is to be dispensed valve assembly #13 is activated and fluid in the reservoir passes up through extension drawl-tube #11. It enters the sprayer body #12 and follows molded conduits up to and through the open valve. In the valve illustrated, valve assemblies #13 and #14 are inserted into sprayer body #12. Valve retainer #15, provided with male threading, screws into a cavity in the sprayer body, which is provided with corresponding female threads. Assembled, valve stem #13 protrudes through valve retainer #15, the protruding end is provided with male threads that allows nozzle #16, having corresponding female threads, to be attached. Conduits for pump chamber #6, valve assembly #13, and their corresponding paths leading to reservoir #10 could run parallel paths to each other in order to simplify the molding process. Parts in assembly # 14 are a spring for returning valve # 13 and a retaining washer that keeps this spring clear of the o-ring sealing area. Product is dispensed through a nozzle #16, which may be interchangeable and or adjustable, have various spray patterns, foaming abilities, or be designed to dispense powdered products. For this type of valve system, nozzle #16 or a notch in valve stem assembly #13 could act as an edge that dispensing-trigger #4 can push against to open the valve and activate flow. A dispensing-trigger of style #4 fits in-between and protrudes through the forward face of the larger compression-trigger #3. Compression-trigger #3 is provided with slots and holes to accommodate various accesses needed for the dispensing-trigger, nozzle, and air intake as required. Compression-trigger #3 may be provided with one style of trigger-guard #17 to help prevent any accidental dispensing of product. Seal/valve-retainer #9 holds pump body #12 to cap #8. It may snap or press fit and may also be provided with fasteners to handle the extra pressure loads it will encounter with a pressurized reservoir. This seal and cap retainer may also act as a retainer for the check-valve #7. Cap #8 screws together with and holds the pump body to its reservoir and creates a mechanical seal. A commonly used filter #19 may also be provided to keep debris from entering the distribution's conduit system.

The subsequent items for FIG. 1 will be applicable to all other designs of this invention. Furthermore, features in the following designs could also be applied to the sprayer in FIG. 1.

Various o-rings and seals for items like valve #13 in FIG. 1 may be added as required. Other seals, some not shown, for areas such as inside the nozzle or between the cap #8 and bottle #10 may also be added as needed.

Air intake #1 may be provided with filter material to provide for a clean air supply.

Check-valves #2 and #7 may vary in their design, being a ball and spring as shown, rubber flaps as found on many compression sprayers, or any other commonly used check-valves. The location of these valves will also vary and may be made removable and repairable if desired.

Dispensing-valves and their means of activation will vary in their designs and locations.

Trigger-guards will vary to accommodate the needs of each trigger design. They may be a protrusion of plastic as in FIG. 1 part #17, a flap, lockout device, and/or any other means for preventing the dispensing valve's actuation during compression strokes.

The source of handgrip powered air pressure could be provided by a piston/plunger style pumping mechanism as shown. It could also be any other type of common pump available such as a bellows, that are activated by a handgrip squeeze fashion.

A pressure relief-valve could be added anywhere in the system to eliminate over-pressurization. They would vary in their type and location to best suite each design. The design of valve assembly # 13 could also relieve extra pressure though it would do so by dispensing product. For this reason the best choice would be utilizing a valve that is located in direct communication with the compressed gas areas.

Trigger lever stop #18 and filter #19 have common features found on most generic spray devices today. Not all of these features are considered common to the present art are listed though they may be incorporated into the new designs of this invention.

FIG. 2 depicts an assembled version of the sprayer in FIG. 1. It shows an exposed dispensing-trigger #4, which is one method of building a trigger that could be operated without retracting compression-trigger #3.

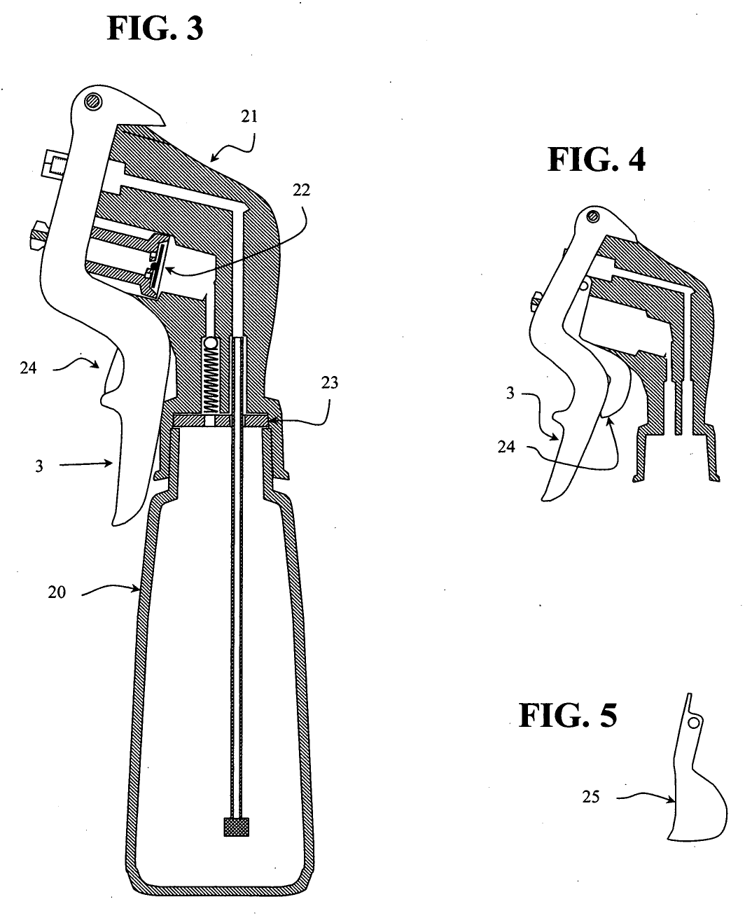

FIG. 3 shows a sprayer in which the sprayer's body and cap are connected into a unitized spray body #21 utilizing a different retainer/seal #23. In this design the compression-trigger is retracted exposing another version of a dispensing-trigger #24. Also depicted here is a rubber flap type check-valve #22 in an alternate location.

FIG. 4 depicts an assembled version of the sprayer in FIG. 3. It shows an exposed dispensing-trigger #24, which is one method of building a dispensing-trigger that would not cause accidental dispensing of product if the sprayer's compression-trigger was used as a hook to hang the sprayer from.

FIG. 5 is another version of a dispensing-trigger similar to trigger #24, in that by having a wider profile and protruding more, it would always be exposed for use.

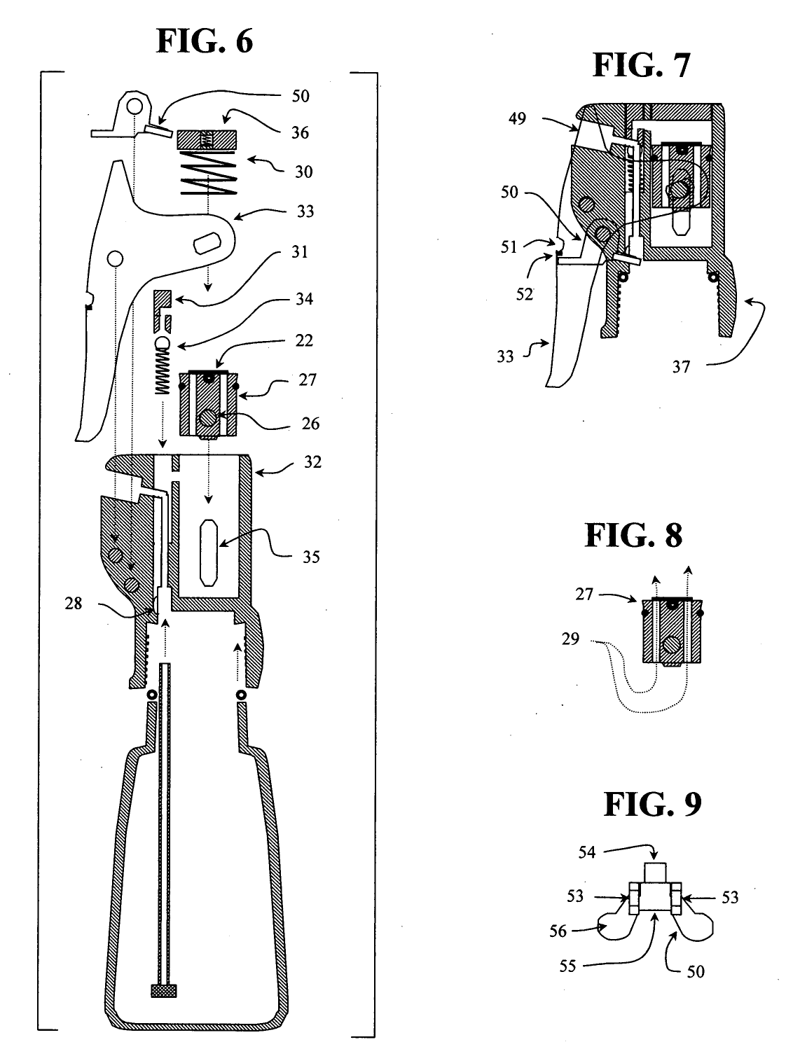

FIG. 6 is an exploded view of a sprayer from this invention model utilizing a vertical pump design that is located above and outside the reservoir chamber. This design may be one of the most practical as it may; use the least material, offer a large amount of air displacement per stroke, and be more compact, when compared to other sprayers of this invention. It will allow for a wide range of pump diameters, lever ratios, and stroke lengths that could be utilized. For this sprayer a dual-purpose trigger #33 acts upon a hinge pin #26 to force the piston upward pushing air in the chamber through check-valve #34 into the reservoir via an outlet #28. A return spring #30 is utilized to return the pump for subsequent strokes. During the release portion of each stroke air that was drawn in through a polarity of open areas #35 passes up through pump piston #27 and past integrated check-valve #22 into the interior of the pump chamber for the following stroke. Open areas #35 also act as the piston guide and hinge areas.

Cap # 36 is used to retain the spring and create a seal for the pump chamber. It may be fitted with an integrated pressure relief valve as shown. It may be threaded, removable, and fitted with various seals if required. Check-valve cap #31, which may be threaded and removable, retains check valve #34. Dual-purpose trigger #33 is used for both air compression and product distribution. For this design the first longer portion of the stroke provides compression while the very last portion provides a means to activate the dispensing-valve. An ambidextrous thumb style trigger stop #50 is provided to keep trigger #33 from entering the dispensing portion of the stroke while compressing the reservoir. To dispense product thumb lever #50 is depressed before or during the first portion of the stroke, which allows the trigger to be fully retracted opening the dispensing-valve. The dispensing-valve not shown may be a generic one similar to the one displayed in FIG. 1 which, is opened when the valve is pulled away from the pump body.

FIG. 7 displays an assembled version of the sprayer in FIG. 6. Here the dual-purpose trigger is retracted to the stopping point provided by trigger-stop #50. Here a ledge or stop edge #52 is provided so stop #50 will remain in an area that provides support. In this case stop #50 uses the front portion of trigger # 33, itself between, and the sprayers body # 32 to provide a very solid stopping point. When actuated stop #50 bypasses ledge #52 and enters area #51, which may be a hole or recessed pocket, it allows dual-purpose trigger #33 to be fully retracted so surface #49 could actuate a dispensing-valve. Also, a comfortable contour to fit the palm of a hand #37 could be added to the cap/sprayer body combination.

FIG. 8 illustrates the directed flow of air #29 through the pump's piston assembly #27.

FIG. 9 is a top elevation view of thumb lever style trigger-stop #50. In this version the lever is activated with a downward and slightly forward thumb motion of the tabs #56 located on either side of the sprayer's head, which allows for ambidextrous use. In this design the thumb tabs are located in the most convenient location available for operating another lever. This lever should also be provided with a spring to return the lever to its lockout mode after each use. A resilient flap of plastic, acting upon or protruding from the sprayer's body, a coiled spring on hinge point #53, or any other simple spring arrangement could be utilized to provide this lever a means for return. Surface #54 acts upon the dual-purpose trigger to provide the lockout stop required. Surface #55 provides a solid support for the trigger-stop against the sprayer's body.

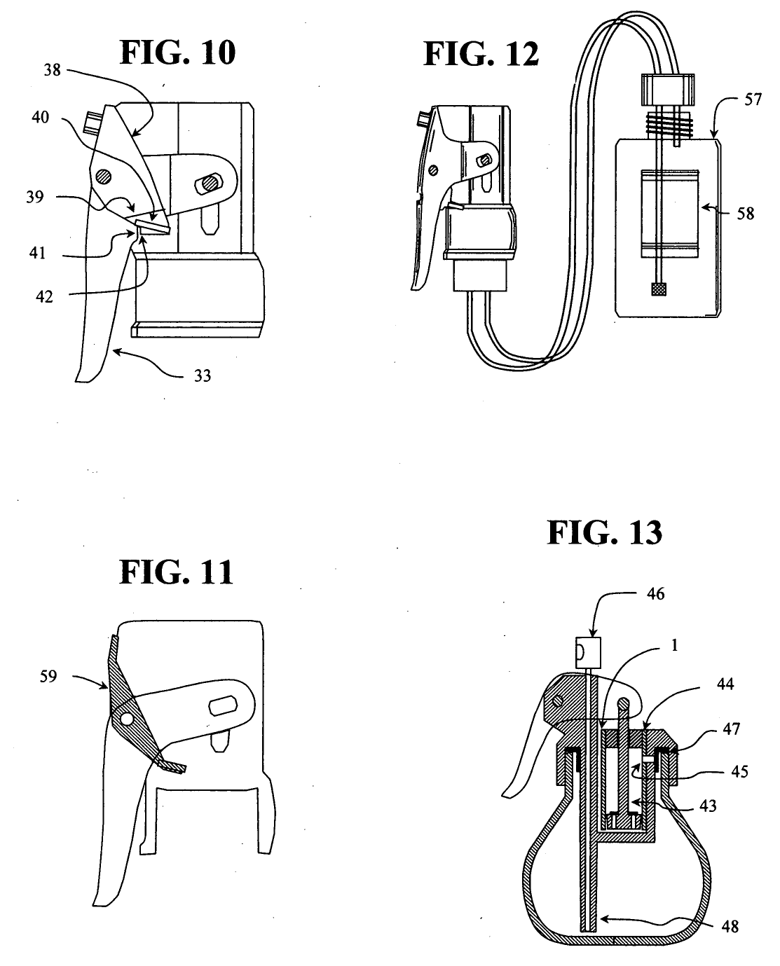

FIG. 10 illustrates an ambidextrous, interacting, thumb lever #38 as a means for operating the dispensing-valve. To dispense product, during the first portion of that stroke, thumb lever pad #40 is depressed downward and inward when pressure is applied to it. This thumb pad area, which is normally flared slightly outward from the sprayers body at bend point #39, flexes inward causing a protruding edge surface #42 to engage with surface #41 on the dual-purpose trigger #33. During operation when these two surfaces engage each other pulling the dual-purpose trigger further will cause lever #38 to pivot opening the dispensing-valve. This system will operate a valve that is opened when pulled out and away from the pump body like the valve depicted in FIG. 1.

FIG. 11 of thumb lever #59 is another type of the many styles of levers that could be used to for activating the dispensing-valve. This lever is a style that works independently from the compressing-trigger. Its hinge point could vary to accommodate the force and displacement it will need to provide. It may be utilized for any of the designs described working in conjunction with a valve that opens in the depressed position. As with all of the designs it would be built symmetrically and allow for ambidextrous use.

FIG. 12 depicts a sprayer of this invention that utilizes a remote reservoir #57. It is also supplied with a method for hanging it by #58.

FIG. 13 embodies another sprayer version of this invention. This is a sprayer where the pump is located within the reservoir chamber. It utilizes a unique rubber style check-valve #47 that could resemble a simple rubber band or in this case a shape that also acts as the reservoir's seal. Other unique features are an integrated drawl-tube #48, and a finger operated dispensing-valve #46. Here the air inlet #1 and its conduit are integrated into the pump liner insert for molding purposes. Air is drawn in through air inlet #1 by interior style pump #43, which is supplied with an integrated check-valve. It is forced into air passage #45, through check-valve #47, and into the reservoir chamber. Depressing nozzle #46 would open a standard valve to dispense the product within the reservoir. In this version, the pump diameter is limited by the diameter of the neck on its reservoir. For volumetric reasons this design may be limited to smaller reservoir sizes. It may also be the most compact of all designs and therefore be the best for fulfilling the needs of the smallest, finger or handgrip powered, one-hand operable, pre-pressurized, air powered sprayers in accordance with this invention. A pump of this design may require only one finger to operate the compression-trigger. This sprayer could also incorporate features described on the previous designs herein as they could also utilize the features found in this sprayer and each other.

It is the main objective of this invention to create a pressurized air sprayer where the means for air compression is provided in a finger or handgrip squeeze motion.

One embodiment of this invention reverses the flow of a bottle-top trigger sprayer. Instead of pumping out fluid the pump now ingests air. The compressed air is deposited into a properly reinforced reservoir. In doing so we convert the trigger sprayer into a pressurized air sprayer. Multiple trigger compression strokes are used to compress air into the reservoir. Product inside the reservoir is pushed out through a conduit to a dispensing-valve supplied with a means for its operation. When the dispensing-valve is opened compressed air in the reservoir is used to dispense product, in a continuous manner, until the product has been depleted or additional pressurizing strokes are required.

In another embodiment a pressurized air sprayer's traditional design utilizes a handgrip squeeze motion to power the pressurizing pump. A sprayer that utilizes finger or handgrip pumping motions and transfers the hand-squeeze motions to power an air pump. The pump supplies compressed air, which is deposited into a reinforced reservoir that contains a product to be distributed. This compressed air is then utilized to dispense the product through a conduit that is provided with a valve to control distribution.

In yet another embodiment, a pressurized sprayer's handheld pump is operated in a hand squeeze manor and is remotely located from the reservoir container. Triggers for pressurizing and dispensing product are operable with one hand. Two flexible tubes are provided one to communicate pressurized air into the reservoir and the other tube to distribute product back to the sprayer body so it can be dispensed.

While several embodiments of this invention have been described, various feature combinations for these sprayers may be combined to form other versions without departing from the main scope of this invention. Thus, the following variations of features for this invention are listed such that their use in different configurations may be readily understood.

PUMP; the pump or pumps for compressing air may be located anywhere that is most effective for each particular design. The pumping device could be made of any common design or style and will vary depending on each individual application.

COMPRESSION-TRIGGER; the pressurizing finger or hand-trigger may be located where a trigger sprayer's trigger normally is, in a somewhat vertical position. Also it may be located on top of a pressurized air sprayer, in a somewhat horizontal position. However, squeezing the pump trigger would require lifting the reservoir, which may not prove to be advantageous. Furthermore, the compression-trigger could be placed in any other location depending on each individual application. One or more fingers in a handgrip squeeze motion may operate this trigger. A compression-trigger may be designed as a pivoting lever, a parallel sliding handle, or a button that is directly or remotely connected to one or more compression pumps.

DISPENSING-VALVE; The type of valve used may be of any common style already available. It may be located anywhere that is most convenient for its use and will vary with each individual sprayer design.

DISPENSING-VALVE'S MEANS FOR OPERATION; the valve could be operated through the use of a second trigger, button, or linkage to a dual-purpose trigger that would provide a means for its operation. A trigger for dispensing may work inside and be protruding through or be along side the compression-trigger. It may also be a button or trigger that is activated with a finger or thumb and be located anywhere convenient or, it could also be operated via a dual-purpose trigger.

DUAL-PURPOSE TRIGGER; a dual-purpose trigger is a trigger that operates both pressurization and dispensing. Two examples of this trigger are disclosed though an array of many lever arrangements could be used to create a dual-purpose trigger that is in accordance with this invention. For a sprayer with a single dual-purpose trigger the compressing trigger also activates the dispensing-valve. In one system described the last portion of the trigger's travel activates product flow. In this system a lockout devise could be provided so pulling the hand-trigger too far will not accidentally dispense product during pressurizing strokes. In a second system the dual-purpose trigger temporarily attaches itself to a means for operating the dispensing-valve. The attaching mechanism should be designed to automatically disengage itself when the trigger is released.

TRIGGER GUARDS; a trigger-guard could be utilized, which prevents activating the dispensing-valve during compression strokes. Any type of trigger-guard that would prevent an accidental dispensing product could be used. It could be any form of mechanical barrier or lockout devise. The trigger-guard may be associated with a button, lever, or any other form of trigger that is used to activate the dispensing-valve. Because the dispensing-valves will vary in type and location their trigger-guards will have to be customized for each particular design.

RESERVOIR; the reinforced reservoirs may vary in size and shape. They may be made larger or smaller to vary the amount of overall weight, pre-pressurizing strokes, and reservoir volume required. They may be provided with a wide footprint for standing upright, as shown in FIG. 1 part #10. Or, be more compact for applications where it is to be hung by its trigger or set into a holder as shown in FIG. 3 part #20. It would be possible to build a reservoir that has multiple flexible bladder reservoirs within it. Each flexible bladder would hold a product of its own and would require additional return conduits for each product. For a sprayer of this design a selectable valve or multiple valves would be utilized to determine which product is to be dispersed.

REMOTE RESEERVOIR; a sprayer design of this invention may be provided with a remotely located reservoir. Here the one hand operable pump/valve sprayer head assembly is tethered to the reservoir by two or more flexible conduits. One conduit transfers compressed air from the sprayer head to the reservoir. The second conduit or conduits are utilized to deliver product from the reservoir to the sprayer head for distribution. The reservoir may be provided with a clip, strap, or any means for attach itself to the user. The sprayer head may also be provided with a means for attaching itself to the reservoir while not in use.

LOCKOUTS; lockouts for various features could be added as desired. This could be the aforementioned lockout that prevents pulling a dual-purpose trigger of this invention too far during the pre-pressurizing mode. One could be used to lock back the pre-pressurizing trigger to keep it fully back and out of the way for easier use when dispensing product. A type of lockout found on many common sprayers today could also be used to lock constantly on or off the dispensing-valve or its trigger.

PRESSURE-RELEIF VALVES; as in many compressed air sprayers pressure-relief valves could be utilized to prevent over pressurizing. The dispensing-valve as in FIG. 1 could provide this means though it would do so by dispensing product. More advantageous would be to provide a pressure-relief valve in direct communication with the compressed gas areas so relief would be provided in the way of a release of excess air.

SHROUDS; decorative shrouds could be added to any of the designs to cover mechanically moving parts and for appearance value. They may also serve as a function for operating the dispensing-valve and be incorporated into a part similar to part #38 in FIG. 10 which, hooks itself to a dual-purpose trigger when its sides are deformed inward.

NOZZLES; nozzles may vary with each application and may be of any generic type. Nozzles may be made adjustable, selectable, and or interchangeable. They may have various spray patterns or spray in a stream and they may also be of the foam generating type. Nozzles may also be designed for spraying powders or other specialty products.

SEALS; the sealing methods illustrated throughout could be simple o-rings or specially formed gaskets for each particular scenario. These sealing methods could vary and substitutions could be made due to effectiveness, cost, and availability.

While several embodiments of this invention have been demonstrated it should be apparent to those skilled in the art that what has been described here is considered, at present, to be the preferred embodiments. There are many ways of executing the construction of a compressed air sprayer in which the power for air compression is provided in a finger or handgrip squeezing motion. It would be possible to configure a sprayer of this invention with many variations in parts, placements, angles, shrouds, and sizes, along with any common forms of seals, valves, pumps, reservoirs, filters, lockouts, and nozzles available. Parts and features described herein should be mixed and matched to form various configurations that would best execute each particular need for that sprayer's application. In accordance with the Patent Statute, changes may be made in the handgrip powered pressurized air sprayer without actually departing from the true spirit and scope of this invention. The appended claims are intended to cover all such changes and modifications which fall under the overall scope of this invention.

What is claimed is:

1. A compressed air sprayer that is pressurized in a finger or handgrip squeeze motion consisting of:
A. A source to compress air in a single-handed finger or handgrip squeeze manor consisting of a pump with two check-valves and a compression-trigger.
B. A reinforced reservoir that receives the said air and holds within itself a product to be dispensed.
C. A product dispensing-conduit with one end in direct fluid communication with the said product and the opposing end in communication to the outer atmosphere via various orifices for product distribution.
D. A system where the said dispensing-conduit is provided with a dispensing-valve and means for its operation.

2. A sprayer of claim 1 wherein the said reservoir is removable and refillable.

3. A sprayer of claim 1 wherein a first conduit is provided to transfer the said compressed air from the said source to the said reservoir.

4. A sprayer of claim 1 wherein both the said first conduit and said dispensing-conduit run parallel paths to each other for ease of molding.

5. A sprayer of claim 1 wherein the said compression-trigger is in a somewhat vertical position. Where a trigger in the form of a lever is hinged to the upper portion of the sprayer body near the lever's top portion, hinged to the said compressed air source in the lever's middle section, and manipulated by a finger or hand-grip squeeze motion at the lever's lower portion.

6. A sprayer of claim 1 wherein the said dispensing-valve's said means for operation is operated utilizing the same hand as the compression strokes used.

7. A sprayer of claim 1 wherein the said dispensing-valve's said means for operation is operated utilizing the same hand that performs compression strokes without repositioning this hand.

8. A sprayer of claim 1 that is provided the; said compressed gas source, said dispensing-valve, and their associated methods of operation, are located remotely from the reservoir chamber via extended-conduits.

9. A sprayer of claim 1 wherein the triggers for both compressing and dispensing are in line with each other, where the said dispensing-valve's trigger is located alongside or within and protruding through the said compression-trigger.

10. A sprayer of claim 1 wherein the said dispensing-valve's said means of operation is angled and contoured so that areas that could be pushed on which would open the said dispensing-valve are hidden within the said compression-trigger. This allows for the compression-trigger to act as a hook to hang the sprayer from without causing accidental dispensing of product.

11. A sprayer of claim 1 wherein the said dispensing-valve's said means for operation in the form of a lever has a hinge point that is located somewhere between the compressing pump and orifice used for product distribution.

12. A sprayer of claim 1 wherein the said dispensing-valve's said means of operation is located or designed so that it allows itself to be operated when the said compression-trigger is not retracted.

13. A sprayer of claim 1 wherein the said dispensing-valve's said means of operation is supplied with a trigger-guard to help prevent accidental dispensing of product.

14. A sprayer of claim 1 wherein the trigger that provides compression also triggers the said dispensing-valve and is a dual-purpose trigger.

15. A sprayer of claim 1 wherein the said dual-purpose trigger is provided with a lockout mechanism that prevents the trigger from being pulled far enough to cause product distribution when using the trigger for compression strokes.

16. A sprayer of claim 1 wherein the triggers for both compressing and dispensing are provided, a temporary attaching device that locks the two together temporarily, converting the compression-trigger into a said dual-purpose trigger.

17. A sprayer of claim 1 and 16 wherein the said temporary-attaching device automatically disengages itself when the said compression-trigger is released.

18. A sprayer of claim 1 wherein an exteriorly located decorative shroud also operates the said dispensing-valve by itself or in combination with a said dual-purpose trigger.

19. A sprayer of claim 1 wherein the air-inlet attaches the pump mechanism to the said compression-trigger.

20. A sprayer of claim 1 wherein the said air-inlet is provided with an air-filter.

21. A sprayer of claim 1 wherein the said air-inlet is also a retainer for one of the said check-valves.

22. A sprayer of claim 1 wherein the said dispensing-valve's stem is provided with an edge where it's said means of operation could manipulate it.

23. A sprayer of claim 1 wherein an orifice for product distribution may be removable, adjustable and or interchangeable.

24. A sprayer of claim 1 wherein the said dispensing-valve's said means of operation utilizes the edge of the said orifice as a way to operate the valve.

25. A sprayer of claim 1 wherein a pressure-relief valve is supplied to prevent the said reservoir from being over pressurized.

26. A sprayer of claim 1 wherein excessive pressure is relieved by the said dispensing-valve.

27. A sprayer of claim 1 wherein the said dispensing-valve's said means for operation is provided by a thumb operated trigger.

28. A sprayer of claim 1 wherein the said dispensing-valve's said means for operation is provide in a way that allows for ambidextrous use.

29. A sprayer of claim 1 wherein the cap portion of sprayer's body is provided a comfortable bulbous contour to fit the palm of the hand.

30. A bottle-top trigger sprayer for which, normal directional flow of the pump is reversed, it ingests air, and uses that air to pressurize a reinforced reservoir bottle containing a product. In where this pressurized air is used to force the product out through an orifice that may be supplied with a valve and means for its operation.

31. A compressed air sprayer where only one hand is used to pressurize air into its reservoir and where that same hand is used to operate the valve for product distribution.
